(19) United States
(12) Patent Application Publication
(10) Pub. No.: US 2026/0251438 A1
(43) Pub. Date: Aug. 27, 2026

(54) MAGNETIC FIELD GENERATOR, TEST SYSTEM AND TEST METHOD

(71) Applicant: Monolithic Power Systems, Inc., Kirkland, WA (US)

(72) Inventors: Aaron Quitugua-Flores, Kirkland, WA (US); Serge Reymond, St Julien en Genevois (FR); Pavel Kejik, Ecublens, VD (CH); Chao Wang, Chengdu, Sichuan (CN); Lian Xia, Chengdu, Sichuan (CN); Ruiqi Chen, Chengdu, Sichuan (CN); Ruediger Richter, JR., Bellevue, WA (US)

(21) Appl. No.: 19/551,880

(22) Filed: Feb. 27, 2026

(30) Foreign Application Priority Data
Feb. 27, 2025 (CN) 202510223442.0

(51) Int. Cl. G01B 7/30

(52) U.S. Cl. CPC G01B 7/30

(57) ABSTRACT

This disclosure provides a magnetic field generator, a test system, and a test method. The magnetic field generator comprises a magnetic field structure, which includes a housing, a first support frame, and a magnet. The housing comprises a first chamber; the first support frame is housed within the first chamber; the first support frame comprises a first rotating shaft and a magnet support structure, which includes a second chamber that houses the magnet; the magnet support structure is housed within the first chamber. This improves testing accuracy, automation level, and stability, and extends the operating life of the motor.

### CROSS-REFERENCE TO RELATED APPLICATIONS

The present application claims priority to, and the benefit of, Chinese application No. 202510223442.0 filed on Feb. 27, 2025, which is incorporated herein by reference in its entirety.

### TECHNICAL FIELD

The present disclosure relates to a magnetic field generator, a test system and a test method, and in particular to a magnetic field generator, a test system and a test method for testing an angle sensor.

### BACKGROUND

As a key element for measuring a rotation angle or angular displacement of a measurement object, an angle sensor is widely used in the fields of industrial automation, robotics, aerospace, automotive electronics, etc. With the diversification of application scenarios and the improvement of accuracy requirements, the performance testing of angle sensors becomes particularly important. Traditional testing equipment has issues such as low degree of automation, uneven generated magnetic field, easy motor aging, large loss, etc., and are particularly obvious in high-temperature and low-temperature test conditions. In addition, the traditional testing equipment is driven by a low-speed motor, which is difficult to meet the test requirements of the angle sensor, or under the drive of a high-speed motor, it is difficult to meet the requirements of magnetic field uniformity and stability.

In order to improve the test efficiency and reduce the test cost, it is necessary to provide a magnetic field generator with high precision, strong stability, and high automation degree suitable for a triple-temperature testing conditions.

### SUMMARY

An embodiment of the present disclosure provides a magnetic field generator, including a magnetic field structure, where the magnetic field structure includes a housing, a first support frame, and a magnet, and the housing includes a first chamber; the first support frame is accommodated in the first chamber; the first support frame includes a first rotating shaft and a magnet support structure, and the first rotating shaft is connected to the motor shaft through the shaft connection unit; the magnet support structure includes a second chamber, and the magnet is accommodated in the second chamber; and the magnet support structure is accommodated in the first chamber.

An embodiment of the present disclosure provides a test system, including a magnetic field generator and a sorter. A device under test (e.g., an angle sensor) is placed above the magnet by a sorter and electrically connected to the test circuit.

An embodiment of the present invention provides a test method, in which a device under test (for example, an angle sensor) is tested by using a magnetic field generator, and the device under test is placed above a magnet for testing. The device under test is tested by the rotating magnetic field generated by the motor driving the magnet to rotate.

According to the magnetic field generator, the test system and the test method provided by the present disclosure, the test accuracy can be improved, the automation level can be improved, the stability can be better, the service life of the motor can be improved, and the test effect can also be ensured and the device aging can be reduced in an extreme test condition.

### BRIEF DESCRIPTION OF DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 schematically illustrates a structural diagram of a magnetic field generator according to an embodiment of the present disclosure;

FIG. 2 schematically illustrates a cross-sectional view of the magnetic field generator of FIG. 1 taken along line C-C.

The same reference numerals in different schematic figures indicate the same or similar parts or features.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid unnecessarily obscuring aspects of the present disclosure. While the disclosure will be described in conjunction with the preferred embodiments, it will be understood that they are not intended to limit the disclosure to these embodiments. On the contrary, the disclosure is intended to cover alternatives, modifications and equivalents, which may be included within the spirit and scope of the disclosure as defined by the appended claims.

Reference to “one embodiment”, “an embodiment”, “an example” or “examples” means: certain features, structures, or characteristics are contained in at least one embodiment of the present disclosure. These “one embodiment”, “an embodiment”, “an example” and “examples” are not necessarily directed to the same embodiment or example, although it may. Furthermore, the features, structures, or characteristics may be combined in one or more embodiments or examples. In addition, it should be noted that the drawings are provided for illustration, and are not necessarily to scale. Throughout the specification and claims, The term “coupled,” as used herein, is defined as directly or indirectly connected in an electrical or non-electrical manner. The terms “a,” “an,” and “the” include plural reference, and the term “in” includes “in” and “on” unless the context clearly dictates otherwise. The term “or” is an inclusive “or” operator, and is equivalent to the term “and/or” herein including “and”, “or” and any combination thereof, unless the context clearly dictates otherwise.

The terms “comprise”, “include”, “have” and any variations thereof, are intended to cover non-exclusive inclusions, such that a process, method, article, or apparatus that comprises a list of elements is not necessarily limited to those elements, but may include other elements not expressly listed or inherent to such process, method, article, or apparatus.

In the present disclosure, unless otherwise expressly specified and limited, the terms “mounted”, “connected”, “connected”, “fixed” and the like should be understood in a broad sense, for example, it may be a fixed connection, a detachable connection, or an integral connection; it may be a mechanical connection or an electrical connection; it may be a direct connection or an indirect connection through an intermediate medium; it may be an internal communication between two elements or an interaction relationship between two elements, unless otherwise expressly limited. A person of ordinary skill in the art may understand specific meanings of the foregoing terms in this disclosure based on a specific situation.

It should be noted that when an element is referred to as being “fixed to” or “disposed on” another element, it may be directly on the other element or there may be an intermediate element. When an element is referred to as being “connected” to another element, it can be directly connected to the other element or intervening elements may also be present.

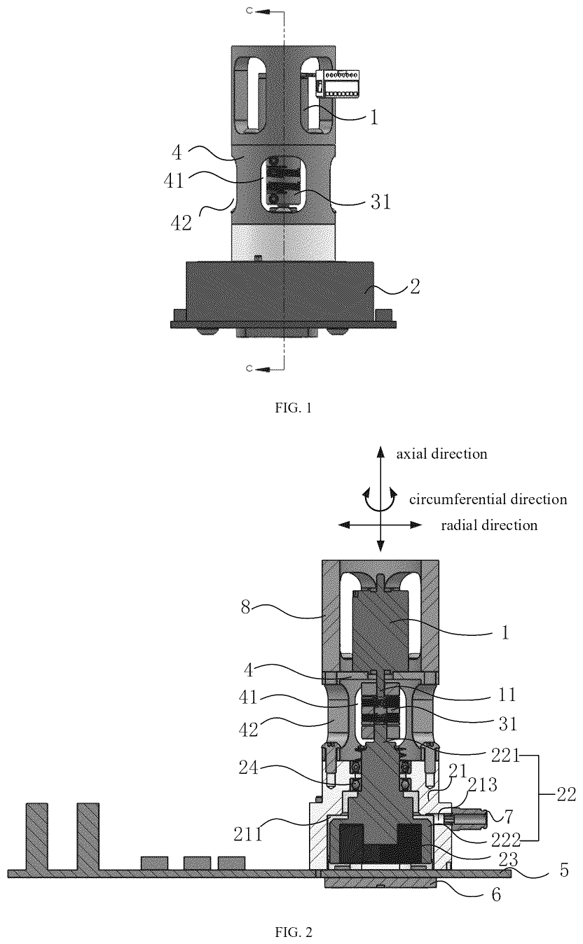

FIG. 1 schematically illustrates a structural diagram of a magnetic field generator according to an embodiment of the present disclosure, FIG. 2 is a sectional view of the schematic structural diagram of the magnetic field generator shown in FIG. 1 along a C-C direction, and for ease of expression, a direction extending along an axis in the FIG. 1-2 can be understood as an axial direction, a direction perpendicular to the axis can be understood as a radial direction, and a direction around the axis can be understood as a circumferential direction.

As shown in FIGS. 1-2, the magnetic field generator includes a magnetic field structure 2, the magnetic field structure 2 includes a housing 21, a first support frame 22 and a magnet 23. The housing 21 includes a first chamber 211, and the first support frame 22 is accommodated in the first chamber 211. The first support frame 22 includes a first rotating shaft 221 and a magnet support structure 222. The magnet support structure 222 includes a second chamber, a magnet 23 is accommodated in the second chamber, and the magnet support structure 222 is accommodated in the first chamber 211.

The magnet support structure 222 is accommodated in the first chamber 211, and the magnet 23 is accommodated in the second chamber of the magnet support structure 222. In an embodiment, the edge of the side wall of the second chamber is flush with or higher than the surface of the magnet 23 essentially. The interference and contamination from the environment to the magnet can be reduced by the structure surrounding the magnet 23 between the second chamber and the magnet 23 to ensure stability and uniformity of the magnetic field. In an embodiment, the magnet 23 may be essentially tightly connected to the side wall of the second chamber.

In an embodiment, the housing 21 is configured to further include a third chamber interconnected with the first chamber 211 via a passage, and the bearing unit 24 is accommodated in the third chamber. The first rotating shaft 221 is mounted in the housing 21 by the bearing unit 24, which takes up the radial load and the axial load generated during the rotation of the first rotating shaft 221, especially at high-speed, thereby improving the stability and mechanical life of the first rotating shaft 221. Further, the housing 21 may include a first step-shaped feature for supporting the bearing unit 24. The bearing unit 24 is in close contact with the housing 21 thereby further improving mechanical stability.

In an embodiment, the bearing unit 24 includes at least two bearings, which can be selected to match the size of the first rotating shaft 221. Spacers are installed between the bearings to reduce vibration.

In an embodiment, the bearing unit 24 may include a rolling bearing, and it should be understood that the present disclosure is not limited thereto, and the bearing can be any other bearing that can play a supporting role, reduce friction, take up radial load and axial load.

In an embodiment, the first support frame 22 is made of non-magnetic material, in particular, the first support frame 22 may be made of copper. The first rotating shaft 221 and the magnet support structure 222 may be integrally molded or may be detachably connected. Using copper as the material of the first support frame 22 can make the first support frame 22 have a certain weight and improve the stability of the magnetic field generator. In addition, copper as a non-magnetic material can reduce the influence on the magnetic field generated by the magnet.

In one embodiment, the housing 21 is made of non-magnetic material. In particular, the housing 21 may be made of polyether-ether-ketone (PEEK), and compared with other non-magnetic materials, using PEEK for the housing provides a better thermal insulation performance, which may reduce damage to the motor under high-temperature test conditions, and thereby extending the motor's operating life. As a result, the magnetic field generator may have a better high-temperature resistance effect. In addition, using the PEEK material to make the housing can eliminate the eddy current effect to make the provided magnetic field more stable and accurate.

In an embodiment, the magnet 23 is configured to be connected to the second chamber of the magnet support structure 222 by resin. Optionally, in order to further prevent the magnet from being polluted by external environment, resin may be coated on the outer surface of the magnet 23.

In an embodiment, the magnet 23 may be selected as a cylindrical magnet, and further, may be selected as a hollow cylindrical magnet, and compared with magnets of other shapes, the magnetic field distribution of the hollow cylindrical magnet is more uniform, thereby reducing eddy current loss and hysteresis loss.

In an embodiment, the magnetic field generator further includes a motor 1, the motor 1 is axially connected to the magnetic field structure 2 through a shaft connection unit, and the motor 1 has a motor shaft 11. When driven by the motor 1, the magnetic structure 2 is rotated through the motor shaft 11, thereby causing the first rotating shaft 221 to spin and generate a rotating magnetic field. This rotating magnetic field can be used, for example, for the testing of an angle sensor.

The motor shaft 11 is connected to the first rotating shaft 221 in the axial direction through the axial connection device, which can improve the radial and axial stability of the first rotating shaft 221 and the motor shaft 11, reduce the radial offset, extend the operating life of the first rotating shaft 221 and the motor shaft 11, improve the stability of the center of the rotating magnetic field generated by the magnetic field generator, and ensure the radial and axial stability of the first rotating shaft 221 and the motor shaft 11 even under high-speed rotation. In addition, through the arrangement of the shaft connection unit, the distance between the motor 1 and the magnet 23 is extended, which prevents the motor 1 from overheating due to a high-temperature test condition in the subsequent test process, and improves the operating life of the motor.

In an embodiment, the shaft connection unit may be configured to include a coupling 31, and the motor shaft 11 is connected to the first rotating shaft 221 through the coupling 31. Compared with a rigid connection such as a threaded joint, the coupling 31 can reduce vibration and stress, thereby preventing deformation of the motor shaft 11 caused by vibration.

In an embodiment, the magnetic field generator is configured to further include a second support frame 4, which includes a fourth chamber 41, and the coupling 31 is accommodated in the fourth chamber 41. The motor 1 is arranged on the second support frame 4, and the motor shaft 11 extends into the fourth chamber 41 and is connected to the first rotating shaft 221 through the coupling 31. In an embodiment, the second support frame 4 is detachably connected to the housing 21, and it can be understood that it may also be mounted in a non-detachable manner, which is not limited in the present disclosure. The second support frame 4 is made of non-magnetic material.

In an embodiment, the second support frame 4 is further configured to include at least one first through hole 42 that extends through its outer sidewall along the circumferential direction (i.e., through the thickness of the wall). The heat dissipation effect of the testing equipment can be improved by providing at least one first through hole 42. It should be understood that the penetration may be in any form, that is, the penetration may be through the thickness of the side wall in the radial direction, or may be through the penetration at any angle with the axial direction, as long as the penetration can realize the interconnect between the fourth chamber and the outside via a passage. The manner in which the first through hole is formed as shown in FIGS. 1-2 is by way of example only and is not intended to be limiting. In addition, it should be understood that the present disclosure is not limited to the arrangement of the through holes along the circumferential direction of the outer sidewall of the second support frame, and is also not limited to the arrangement of the through holes penetrating the outer sidewall along the thickness direction.

In an embodiment, the magnetic field generator may further include a printed circuit board (PCB board) 5 detachably mounded on the housing 21. It can be understood that it can also be mounted in a non-detachable manner, which is not limited in the present disclosure. The PCB 5 covers the first chamber 211, and in particular, the PCB 5 completely covers and closes the first chamber 211, so that the magnet 23 is in a closed environment, which further prevents the magnet from being interfered and contaminated by the external environment, for example, prevents the magnet from being interfered by the spatial magnetic field due to attraction of magnetic substances, and improves the stability of the magnetic field.

In an embodiment, the PCB 5 is provided with a test socket 6. When the magnetic field generator is used for testing, a device under test (such as an angle sensor under test) is disposed on the test socket 6 and electrically connected to the test socket 6. It should be understood that other structures that can realize the electrical connection between the device under test and the test circuit in/on the PCB 5 can be understood as the test socket of the present disclosure. The test base 6 is configured to be disposed opposite to the magnet 23, which may be understood as that the test base 6 and the magnet 23 are disposed on two sides of the PCB 5 and the test base 6 is within a magnetic field range generated by the magnet 23. It can be understood that the present disclosure is not limited thereto, as long as the test base 6 is within the magnetic field range generated by the magnet 23. Optionally, the device under test is located above the center of the magnetic field when disposed on the test socket 6. The PCB 5 is configured to include a control circuit, and the control circuit is connected to the motor 1 to control the rotation of the motor 1.

In an embodiment, the motor 1 may be a DC motor, and in another optional embodiment, the motor 1 may be a high-speed motor, for example, the power frequency of the motor 1 may be 60 Hz, and it should be understood that the power frequency of 60 Hz is only an example and is not intended to be limiting.

In a use situation with high safety requirements, such as a vehicle, it is required that the angle sensor can maintain an extremely low angle nonlinear error under various extreme working conditions, so it is necessary to perform a triple-temperature test (e.g., −40° C. to 150° C.) on the angle sensor in three different temperature conditions: high temperature condition(e.g., up to 150° C.), normal temperature condition and low temperature condition (e.g., down to −40° C.). In order to further improve the stability of the magnetic field generator, in an embodiment, the housing 21 is provided with an air hole 213, the air hole 213 may be configured to be connected to an airflow device (not shown), and optionally, the air hole 213 may be connected to the airflow device through a joint 7. The airflow generated by the airflow device cools or defrosts the magnetic field generator. In a high-temperature test condition, the temperature of the device increases, and heat dissipation through airflow can reduce or avoid problems such as deformation and aging caused by high temperature. For example, the magnetic field generator of the present disclosure can reduce the temperature of the device from 87° C. to 44° C. in a 150° C. test condition. In a low-temperature test condition, water vapor in the air will condense in the device, which will reduce the rotational speed of the motor, reduce the test accuracy, reduce the operation life of the motor, prevent frosting in the device through airflow, ensure that the rotational speed of the motor is constant, ensure the test accuracy, and slow down the aging of the motor.

In an embodiment, the magnetic field generator may further include a third support frame 8 surrounding the motor 1 for supporting and protecting the motor 1. The third support frame 8 is further configured to include at least one second through hole that extends through its outer sidewall along the circumferential direction (i.e., through the thickness of the wall). The heat dissipation effect of the magnetic field generator can be improved by providing the at least one second through hole. It should be understood that the penetration may be a penetration in any form, that is, the penetration may be a penetration through the thickness of the side wall in the radial direction or a penetration through the side wall at any angle with the axial direction, as long as the penetration can realize the interconnect between the space for accommodating the motor 1 and the outside via a passage. In addition, it should be understood that the present disclosure is not limited to the arrangement of the through holes along the circumferential direction of the outer sidewall of the third support frame, and is also not limited to the arrangement of the through holes penetrating the outer sidewall along the thickness direction. The third support frame 8 is made of non-magnetic material.

A test system includes the magnetic field generator in any of the foregoing embodiments and a sorter. A device under test (e.g., an angle sensor) is placed above the magnet 23 by a sorter and electrically connected to the test circuit. In one embodiment, a device under test is placed in the test socket in electrical connection with the test circuit. In an embodiment, the magnetic field generator is mounted on the sorter through a device support frame.

In a test method, a device under test (for example, an angle sensor) is tested by using the magnetic field generator in any one of the foregoing embodiments, and the device under test is placed above the magnet 23 for testing. The device under test is tested by the rotating magnetic field generated by the motor driving the magnet to rotate. In an embodiment, the tested devices are tested in three different temperature testing conditions: high temperature condition, normal temperature condition, and low temperature condition.

The magnetic field generator, the test system and the test method disclosed in the present invention can improve the test accuracy, improve the automation level, have better stability, improve the service life of the motor, and can also ensure the test effect and reduce the aging of the device in extreme test conditions.

Some specific embodiments described above are merely illustrative of the magnetic field generating apparatus, the test system and the test method of the embodiments of the present disclosure. These examples are not intended to be exhaustive or to limit the scope of the invention. Variations and modifications to the disclosed embodiments are possible, and other possible alternative embodiments and equivalent variations to the elements of the embodiments will be apparent to those of ordinary skill in the art. Other changes and modifications of the disclosed embodiments of the present disclosure do not exceed the spirit of the present disclosure and the protection scope defined by the claims.

1. A magnetic field generator, comprising:
a magnetic field structure comprises a housing, a first support frame and a magnet; wherein
the housing comprises a first chamber, and the first support frame is accommodated in the first chamber; and wherein
the first support frame comprises a first rotating shaft and a magnet support structure, wherein the magnet support structure comprises a second chamber, and wherein the magnet is accommodated in the second chamber; and wherein the magnet support structure is accommodated in the first chamber.

2. The magnetic field generator according to claim 1, wherein the housing is configured to comprise a third chamber, a bearing unit is accommodated in the third chamber, and the bearing unit is configured to mount the first rotating shaft in the housing; and wherein
the bearing unit comprises at least two bearings, and at least one gasket is arranged between the at least two bearings.

3. The magnetic field generator according to claim 1, wherein the first supporting frame is made of copper.

4. The magnetic field generator according to claim 1, wherein the housing is made of polyether-ether-ketone.

5. The magnetic field generator according to claim 1, wherein the magnet is configured to be connected to the second chamber of the magnet support structure by resin.

6. The magnetic field generator according to claim 1, wherein a surface of the magnet that is not in contact with the second chamber is coated with resin.

7. The magnetic field generator according to claim 1, wherein the magnet is configured as a hollow cylindrical magnet.

8. The magnetic field generator according to claim 1, wherein the magnetic field generator further comprises a motor, the motor is axially connected to the magnetic field structure by using a shaft connection unit, and the motor comprises a motor shaft; and wherein
the shaft connection unit comprises a coupling, and the motor shaft is connected to the first rotating shaft through the coupling.

9. The magnetic field generator according to claim 8, wherein the magnetic field generator comprises a second support frame, the second support frame has a fourth chamber, the motor is disposed on the second support frame, and the shaft connection unit is accommodated in the fourth chamber.

10. The magnetic field generator according to claim 9, wherein the outer side wall of the second support frame is provided with at least one first through hole that can be ventilated; and wherein
the at least one first through hole is disposed along a circumferential direction of an outer sidewall of the second support frame and penetrates the outer sidewall in a thickness direction.

11. The magnetic field generator according to claim 8, wherein the magnetic field generator comprises a PCB, and the PCB is detachably connected to the housing and completely covers the first chamber; and wherein
a test socket is disposed on the PCB, and the test socket is disposed opposite to the magnet;
a control circuit is disposed on the PCB, and the control circuit is connected to the motor.

12. The magnetic field generator according to claim 1, wherein the housing is provided with an air hole, and the air hole is configured to be connected to an airflow device.

13. A test system, comprising
a magnetic field generator and a sorter, wherein
the magnetic field generator comprise a magnetic field structure comprises a housing, a first support frame and a magnet, the housing comprises a first chamber, and the first support frame is accommodated in the first chamber; and wherein
the first support frame comprises a first rotating shaft and a magnet support structure, the magnet support structure comprises a second chamber, and the magnet is accommodated in the second chamber; and the magnet support structure is accommodated in the first chamber; and wherein
the sorter is configured to place a device under test above a magnetic field of the magnetic field generating apparatus.

14. The test system according to claim 13, wherein the magnetic field generator is mounted on the sorter through a device support frame.

15. The test system according to claim 13, wherein the housing is configured to comprise a third chamber, a bearing unit is accommodated in the third chamber, and the bearing unit is configured to mount the first rotating shaft in the housing; wherein
the bearing unit comprises at least two bearings, and at least one gasket is arranged between the at least two bearings.

16. The test system according to claim 13, wherein the housing is made of polyether-ether-ketone.

17. The test system according to claim 13, wherein the first supporting frame is made of copper.

18. The test system according to claim 13, wherein a surface of the magnet that is not in contact with the second chamber is coated with resin.

19. A test method, comprising testing a device under test by using a magnetic field generator, wherein
the magnetic field generator comprise a magnetic field structure comprises a housing, a first support frame and a magnet, the housing comprises a first chamber, and the first support frame is accommodated in the first chamber; and wherein
the first support frame comprises a first rotating shaft and a magnet support structure, the magnet support structure comprises a second chamber, and the magnet is accommodated in the second chamber; and the magnet support structure is accommodated in the first chamber

20. The test method according to claim 19, wherein device under test are tested in high temperature, normal temperature and low temperature test conditions, respectively.
